(19) United States
(12) Patent Application Publication
(10) Pub. No.: US 2026/0170813 A1
(43) Pub. Date: Jun. 18, 2026

(54) APPARATUS AND METHOD FOR DEFENDING HUMAN DETECTION MODEL AGAINST ADVERSARIAL PATCH ATTACKS

(71) Applicant: Foundation of Soongsil University-Industry Cooperation, Seoul (KR)

(72) Inventors: Dae Seon CHOI, Daejeon (KR); So Hee PARK, Seoul (KR); Ha Yeon JEONG, Seoul (KR)

(73) Assignee: Foundation of Soongsil University-Industry Cooperation, Seoul (KR)

(21) Appl. No.: 19/420,941

(22) Filed: Dec. 16, 2025

(30) Foreign Application Priority Data
Dec. 17, 2024 (KR) 10-2024-0188803

(51) Int. Cl. G06V 10/776; G06F 21/55; G06V 10/26; G06V 10/75; G06V 10/82; G06V 40/10

(52) U.S. Cl. CPC G06V 10/776; G06F 21/554; G06V 10/267; G06V 10/759; G06V 10/82; G06V 40/10; G06F 2221/034

(57) ABSTRACT

An apparatus and method for defending a human detection model against adversarial patch attacks are disclosed. An apparatus for defending a human detection model against adversarial patch attacks according to the present disclosure includes a memory storing one or more instructions, and a processor configured to execute the one or more instructions. The processor receives a first image and a second image, selects, in the first image, a region where an adversarial patch is expected to be present, generates a third image by masking, in the second image, a region corresponding to the region selected from the first image, and detects an object by using the third image.

### CROSS-REFERENCE TO RELATED APPLICATION

The present application claims priority under 35 U.S.C. § 119(a) to Korean patent application number 10-2024-0188803 filed on Dec. 17, 2024, in the Korean Intellectual Property Office, the entire disclosure of which is incorporated by reference herein.

### BACKGROUND

### 1. Technical Field

The present disclosure relates to an artificial intelligence model, and more particularly, to a technology for defending against adversarial attacks in an artificial intelligence model for detecting humans.

### 2. Related Art

Artificial intelligence models are widely used in various fields, and in particular, models for detecting humans play an important role in areas such as autonomous driving of vehicles, military applications, and security.

However, when an adversarial patch is used in an artificial-intelligence-model-based human detection system, the human detection performance may deteriorate, which can pose a serious risk in environments where real-time operation and safety are critical.

An adversarial patch attack exploits vulnerabilities of a neural network model to cause a failure in detecting a person (hiding), to induce recognition of a person as an incorrect object (altering), or to cause detection of a person that does not exist (creating a phantom). Such attacks are highly dangerous because they can be easily implemented not only in digital environments but also in physical environments.

Since the related art has mainly focused on defending against adversarial patch attacks in digital environments, research on defending against physical adversarial patch attacks—such as cases in which a person directly holds a patch to interfere with detection—has been insufficient.

The inventors of the present disclosure have conducted extensive research efforts to address the above-described problems of human detection attacks using adversarial patches, and have completed the present disclosure, which is capable of defending against RGB-based adversarial patch attacks by using thermal image information.

### SUMMARY

In order to address the problems of the related art described above, the present disclosure aims to provide an apparatus and a method for defending a human detection model against adversarial patch attacks by using thermal images together with RGB images to mitigate the effects of such attacks.

The technical problems to be solved in the present disclosure are not limited to the technical problems mentioned above, and other technical problems not mentioned will be clearly understood by those of ordinary skill in the art from the following description.

To solve the above technical problems, an apparatus for defending a human detection model against adversarial patch attacks may include a memory storing one or more instructions; and a processor configured to execute the one or more instructions stored in the memory, and the processor may receive a first image and a second image, the first image and the second image being images obtained by capturing a same object with a same field of view; select, in the first image, a region where an adversarial patch is expected to be present; generate a third image by masking, in the second image, a region corresponding to the region selected from the first image; and detect an object by using the third image.

In an exemplary embodiment of the present disclosure, the first image may be a thermal image captured by an infrared camera, and the second image may be an RGB image captured by an optical camera.

In an exemplary embodiment of the present disclosure, the object may be a person or an animal.

In an exemplary embodiment of the present disclosure, the memory may store an object detection artificial intelligence model, and the processor may compare object detection results obtained from the second image and the third image by using the object detection artificial intelligence model, and determine whether an adversarial patch is present in the second image.

In an exemplary embodiment of the present disclosure, the memory may store an object detection artificial intelligence model, and the processor may perform object detection on each of the plurality of third images by using the object detection artificial intelligence model and obtain an object detection result from an image having a highest confidence score.

In an exemplary embodiment of the present disclosure, the object detection artificial intelligence model may be a YOLOv5 model.

In an exemplary embodiment of the present disclosure, the processor may convert the first image into a Lab color space and perform an initial segmentation; measure similarity of the initially segmented regions based on color, size, and fill; and merge regions having high similarity to generate a bounding box as a region where an adversarial patch is expected to be present, thereby selecting, in the first image, a region where an adversarial patch is expected to be present.

To solve the above technical problems, a method for defending a human detection model against adversarial patch attacks may include receiving a first image and a second image, the first image and the second image being images obtained by capturing a same object with a same field of view; selecting, in the first image, a region where an adversarial patch is expected to be present; generating a third image by masking, in the second image, a region corresponding to the region selected from the first image; and detecting an object by using the third image.

According to the present disclosure, the effects of physical adversarial patch attacks can be mitigated by using RGB images together with thermal images.

In addition, by mitigating adversarial patch attacks, the present disclosure can improve the detection performance of a human detection model and reduce potential risks.

The effects of the present disclosure are not limited to those mentioned above, and other effects not mentioned will be clearly understood by those of ordinary skill in the art from the following description.

### BRIEF DESCRIPTION OF THE DRAWINGS

FIG. 1 is a schematic structural diagram of an apparatus for defending a human detection model against adversarial patch attacks according to an exemplary embodiment of the present disclosure.

FIGS. 2A and 2B illustrate examples of a first image and a second image used in an apparatus for defending a human detection model against adversarial patch attacks according to an exemplary embodiment of the present disclosure.

FIGS. 3A, 3B, and 3C illustrate an example of generating bounding boxes in an apparatus for defending a human detection model against adversarial patch attacks according to an exemplary embodiment of the present disclosure.

FIGS. 4A, 4B, and 4C illustrate an example of generating masking images in an apparatus for defending a human detection model against adversarial patch attacks according to an exemplary embodiment of the present disclosure.

FIGS. 5A and 5B illustrate an example of detecting or mitigating an adversarial patch in an apparatus for defending a human detection model against adversarial patch attacks according to an exemplary embodiment of the present disclosure.

FIG. 6 is a schematic flowchart of a method for defending a human detection model against adversarial patch attacks according to another exemplary embodiment of the present disclosure.

### DETAILED DESCRIPTION OF THE EMBODIMENTS

[National Research and Development Project that supported this invention]
[Assignment Unique Number] 2710008649
[Assignment Number] II210511 (2021-0-00511)
[Name of the Ministry] Korea Ministry of Science and ICT
[Name of the Assignment Managing (Professional) Organization] Institute for Information & Communications Technology Planning & Evaluation (IITP)
[Research Project Title] Core Information Security Original Technology Development (R&D)
[Assignment Title] Development of Robust AI and Distributed Attack Detection Technology for Edge AI Security
[Name of the Organization Performing the Assignment] Soongsil University Industry-Academic Cooperation Foundation
[Research Period] Apr. 1, 2021-Dec. 31, 2026
[Assignment Unique Number] 2710008252
[Assignment Number] 00398353 (RS-2024-00398353)
[Name of the Ministry] Korea Ministry of Science and ICT
[Name of the Assignment Managing (Professional) Organization] Institute for Information & Communications Technology Planning & Evaluation (IITP)
[Research Project Title] Core Information Security Original Technology Development (R&D)
[Assignment Title] Development of Security Threat Response Technology for Generative AI
[Name of the Organization Performing the Assignment] Soongsil University Industry-Academic Cooperation Foundation
[Research Period] Apr. 1, 2024-Dec. 31, 2027

The above-mentioned objects, means, and effects thereof of the present disclosure will become more apparent from the following detailed description in relation to the accompanying drawings, and accordingly, those skilled in the art to which the present disclosure belongs will be able to easily practice the technical idea of the present disclosure. In addition, in describing the present disclosure, when it is determined that a detailed description of a related known technology may unnecessarily obscure the subject matter of the present disclosure, the detailed description will be omitted.

The terms used in this specification are for the purpose of describing embodiments only and are not intended to limit the present disclosure. In this specification, the singular forms “a,”, “an,” and “the” also include plural forms in some cases unless otherwise specified in the context. In this specification, terms such as “include”, “comprise”, “provide” or “have” do not exclude the presence or addition of one or more other elements other than elements mentioned.

In this specification, terms such as “or” and “at least one” may represent one of the words listed together or a combination of two or more thereof. For example, “A or B” and “at least one of A and B” may include only one of A or B, or may also include both A and B.

In this specification, descriptions according to “for example”, etc. may not exactly match the information presented, such as the recited properties, variables, or values, and effects such as modifications, including tolerances, measurement errors, limits of measurement accuracy, and other commonly known factors should not limit the modes for carrying out the invention according to the various exemplary embodiments of the present disclosure.

In this specification, when an element is described as being “connected” or “linked” to another element, it will be understood that it may be directly connected or linked to the other element, but intervening elements may also be present. On the other hand, when an element is referred to as being “directly connected” or “directly linked” to another element, it will be understood that there are no intervening elements present.

In this specification, when an element is described as being “on” or “adjacent to” another element, it will be understood that it may be directly “on” or “connected to” the other element, but intervening elements may also be present. On the other hand, when an element is described as being “directly on” or “directly adjacent to” another element, it will be understood that there are no intervening elements present. Other expressions describing the relationship between the elements, for example, “between” and “directly between”, and the like can be construed similarly.

In this specification, terms such as “first” and “second” may be used to describe various elements, but, the above elements should not be limited by the terms above. In addition, the above terms should not be construed as limiting the order of each element, and may be used for the purpose of distinguishing one element from another. For example, a “first element” may be named as a “second element” and similarly, a “second element” may also be named as a “first element.”

Unless otherwise defined, all terms used in this specification may be used with meanings commonly understood by those of ordinary skill in the art to which the present disclosure belongs. In addition, terms defined in a commonly used dictionary are not interpreted ideally or excessively unless explicitly and specifically defined.

Hereinafter, preferred embodiments according to the present disclosure will be described in detail with reference to the accompanying drawings.

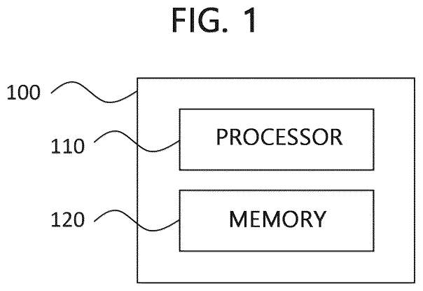

FIG. 1 is a schematic structural diagram of an apparatus for defending a human detection model against adversarial patch attacks according to an exemplary embodiment of the present disclosure.

An apparatus 100 for defending a human detection model against adversarial patch attacks according to the present disclosure may include one or more processors 110 and a memory 120.

The memory 120 may store instructions, data structures, and program code that can be read by the processor 110. In the exemplary embodiments, at least the operations performed by the processor 110 may be implemented by executing the instructions or code of a program stored in the memory 120.

The memory 120 may include a flash memory type, a hard disk type, a multimedia card micro type, or a card-type memory (e.g., SD or XD memory), and may include non-volatile memory such as ROM (Read-Only Memory), EEPROM (Electrically Erasable Programmable Read-Only Memory), PROM (Programmable Read-Only Memory), magnetic memory, magnetic disks, or optical disks, and volatile memory such as RAM (Random Access Memory) or SRAM (Static Random Access Memory).

The memory 120 may store one or more instructions or programs that can be used by the processor 110 to search for a patch for an adversarial attack in an image.

The processor 110 controls overall operations of the apparatus 100 for defending a human detection model against adversarial patch attacks. For example, by executing one or more instructions stored in the memory 120, the processor 110 may control overall operations of the apparatus 100 for defending a human detection model against adversarial patch attacks to detect an adversarial patch by using a thermal image and an RGB image.

The processor 110 may include, for example, at least one of a central processing unit (CPU), a microprocessor, a graphics processing unit (GPU), an application-specific integrated circuit (ASIC), a digital signal processor (DSP), a digital signal processing device (DSPD), a programmable logic device (PLD), a field programmable gate array (FPGA), an application processor, a neural processing unit (NPU), or a processor dedicated to artificial intelligence designed with a hardware architecture specialized for processing AI models, but is not limited thereto.

The processor 110 receives a first image and a second image and detects an adversarial patch intended to attack a human detection model.

The first image may be a thermal image captured by an infrared thermal camera, and the second image may be an RGB image captured by an optical camera at the same position and with the same field of view corresponding to the first image. Here, “the same” includes not only a case in which the images physically match completely, but also a case in which most fundamental information matches to an extent that allows the two images to be applied to the present disclosure. Of course, the two images may be captured at the same time. The phrase “the same time” does not refer only to an exactly identical moment, but may also include a short time interval in which most fundamental information matches to an extent that allows the present disclosure to be applied.

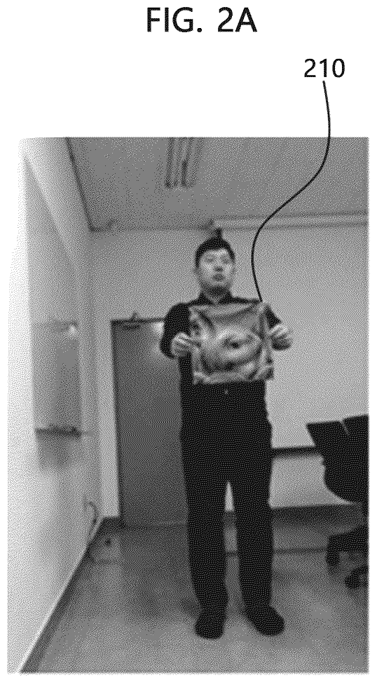

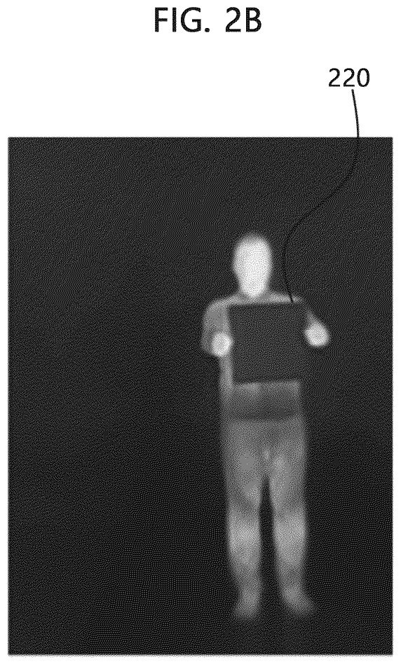

FIGS. 2A and 2B illustrate examples of a first image and a second image used in an apparatus for defending a human detection model against adversarial patch attacks according to an exemplary embodiment of the present disclosure.

FIG. 2A illustrates an example of an RGB image serving as the second image, and FIG. 2B illustrates an example of a thermal image serving as the first image.

The second image includes an adversarial patch 210 intended to attack an artificial intelligence human detection model.

A general RGB image including such an adversarial patch 210 has a vulnerability in that the person may not be detected by attacking weaknesses of the artificial intelligence model for human detection.

The present disclosure aims to defend against such human detection attacks by detecting an adversarial patch in a thermal image and masking the corresponding region in the RGB image.

The processor 110 detects an adversarial patch region in the thermal image, that is, the first image.

In the case of a thermal image, a paper-based adversarial patch exhibits a difference in thermal radiation compared to a human body, and this characteristic is used to detect the adversarial patch.

The processor 110 first performs segmentation on the first image.

Segmentation may be performed by using a selective search algorithm. Since the selective search algorithm is a well-known technique, a detailed description thereof will be omitted.

The processor 110 first converts the first image into a Lab color space and then performs an initial segmentation. At this time, K may be set to 100, although the present disclosure is not limited thereto.

The processor 110 measures similarity of the initial segmentation results based on color, size, and fill, and then repeatedly performs segmentation on regions that are similar to one another. Performing segmentation on similar regions may include generating merged segmentation results among segmentation objects arranged in similar regions.

After repeating the segmentation, the processor 110 selects bounding boxes that satisfy a predetermined threshold.

For example, the processor 110 may filter bounding boxes by setting minimum and maximum sizes of the bounding boxes, and may remove bounding boxes having an IoU threshold of 0.2 or more through an NMS process.

Through this process, the processor 110 may select the top 80 regions as final bounding boxes, although the present disclosure is not limited to this number.

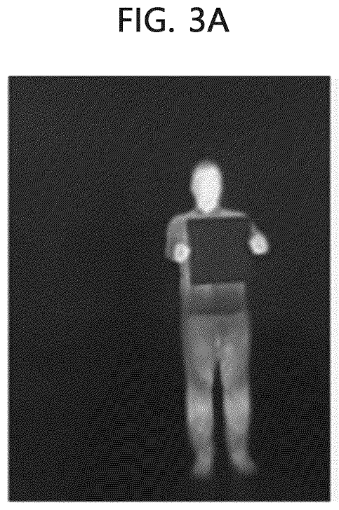

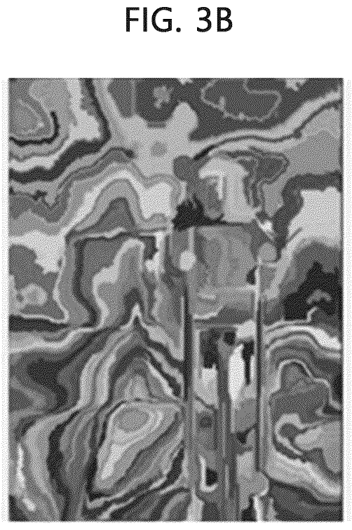

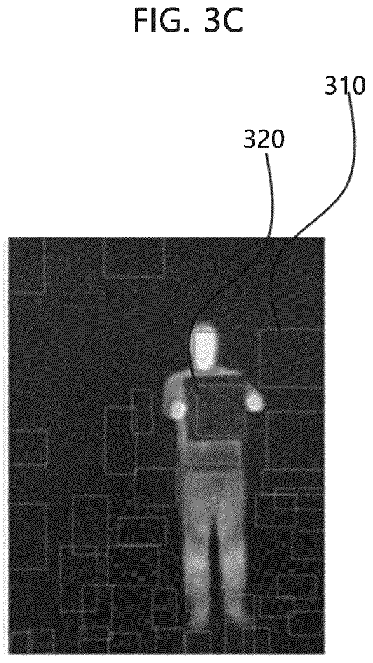

FIGS. 3A, 3B, and 3C illustrate an example of generating bounding boxes in an apparatus for defending a human detection model against adversarial patch attacks according to an exemplary embodiment of the present disclosure.

FIG. 3A illustrates an example of an original first image (thermal image), and FIG. 3B illustrates results obtained by performing initial segmentation.

When bounding boxes are generated based on similarity in FIG. 3B, the result appears as shown in FIG. 3C.

The bounding boxes 310 and 320 represent candidate regions in which an adversarial patch may be present. That is, a mask set is generated for regions in which an adversarial patch is expected to exist.

The processor 110 generates a masking image by using the generated bounding boxes, that is, the mask set.

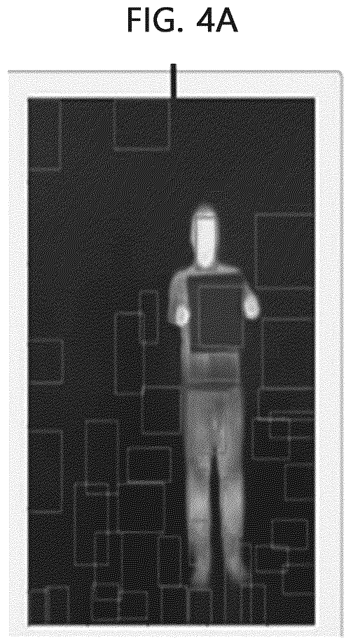

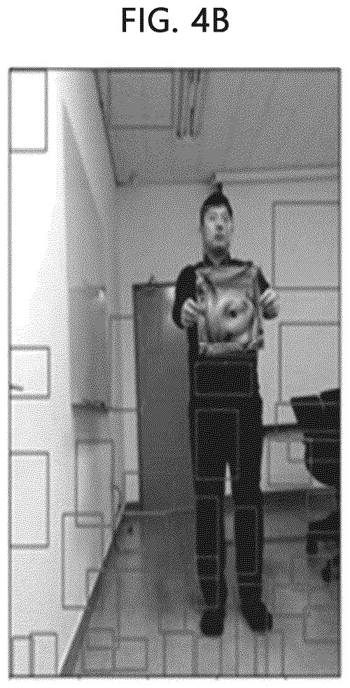

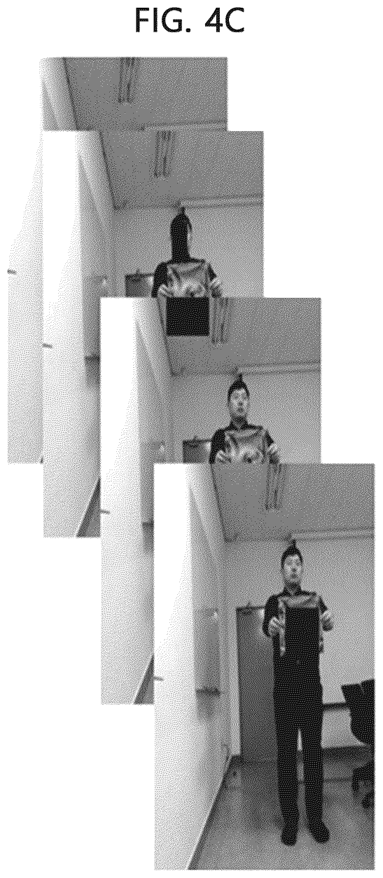

FIGS. 4A, 4B, and 4C illustrate an example of generating masking images in an apparatus for defending a human detection model against adversarial patch attacks according to an exemplary embodiment of the present disclosure.

FIG. 4A illustrates the first image used to generate the mask set, and FIG. 4B illustrates the second image used to generate the masking image.

When the mask set is generated by using the first image, which is a thermal image, in FIG. 4A and applied to the second image, which is an RGB image, a plurality of third images, as shown in FIG. 4C, are generated by the number of masks included in the mask set. FIG. 4C illustrates only some examples among the entire masks.

The processor 110 may detect an adversarial patch or perform object detection in which the adversarial patch is mitigated by using the generated masking images.

Hereinafter, the processor 110 will be described as detecting a person; however, it is obvious that the present disclosure may also be applied to object detection including animals.

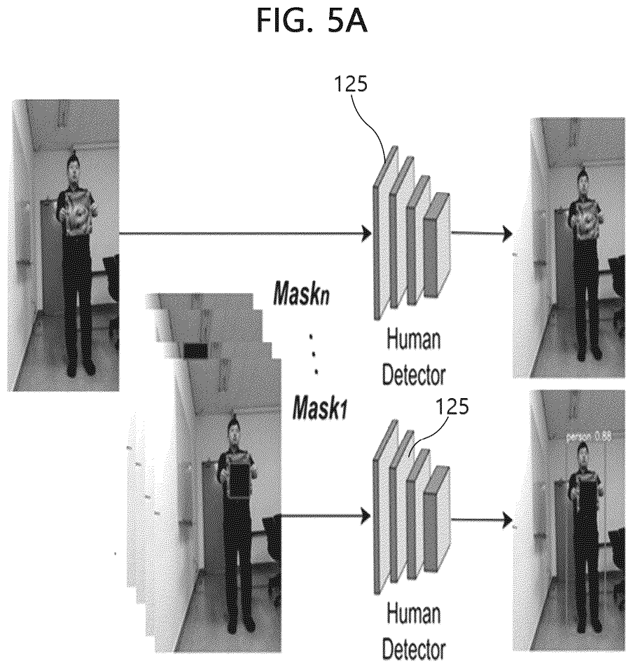

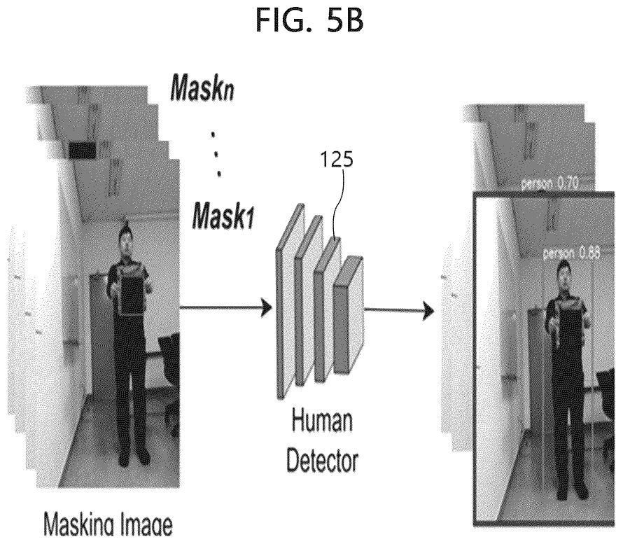

FIGS. 5A and 5B illustrate an example of detecting or mitigating an adversarial patch in an apparatus for defending a human detection model 125 against adversarial patch attacks according to an exemplary embodiment of the present disclosure.

FIG. 5A illustrates an example in which the present disclosure is used to detect whether an adversarial patch exists in an RGB image.

In FIG. 5A, the processor 110 detects a person in the second image, which is the original RGB image, by using the human detection model 125, and detects a person in the previously generated masking images (Mask 1 to Mask n) or third images and compares the results.

To this end, the processor 110 may include an artificial intelligence model for object detection, and in particular, may include the human detection model 125.

As an example of the human detection model, YOLOv5 may be used, although the present disclosure is not limited thereto.

The YOLOv5 model is a one-stage object detection model that provides high speed and accuracy, and it receives an image as input and returns, for each object in the image, a class, bounding-box coordinates (x, y, height, width), an object score, and a confidence score.

The YOLOv5 model, which is an artificial intelligence model, may be pretrained using datasets such as INRIA and COCO, and the loss weights may be set to 1.0 for saliency loss, 2.5 for TV loss, 0.1 for NPS, and 3.0 for the objectness score.

If an adversarial patch is present, the output of the human detection model for the second image will indicate that no person is detected, whereas a person will be detected in the third images in which the region containing the adversarial patch is masked. Accordingly, the presence and location of the adversarial patch can be detected based on these results.

Table 1 below shows results of detecting an attack using an adversarial patch.

TABLE 1

| Target Model | Clean Accuracy | Attack Detection Rate |
|---|---|---|
| Yolov5 (INRIA) | 1.000 | 0.842 |
| Yolov5 (COCO) | 0.993 | 0.831 |

In the case where no adversarial patch is present (Clean Accuracy), the human detection probability was very high at 100% or 99.3%, and even when an adversarial patch was present, the detection probability (Attack Detection Rate) remained high at 84.2% and 83.1%, depending on the model.

FIG. 5B illustrates a process in which the processor 110 inputs masking images in which the adversarial patch has been mitigated into the artificial intelligence model 125 for object detection to detect a person.

A plurality of third images in which the bounding boxes are masked are generated from the second image, and the processor inputs the plurality of third images into the human detection model 125 to generate human detection information. The human detection information may include, for the above-described object, a class, bounding-box coordinates (x, y, height, width), an object score, and a confidence score.

Among the plurality of masking images, the image in which the adversarial patch is masked outputs the highest confidence score.

Accordingly, the processor 110 may select, as a final image in which the adversarial patch is masked, the image having the highest score among the plurality of third images, and may also determine the location and size of the adversarial patch.

Table 2 below shows results of performing human detection after mitigating the adversarial patch.

TABLE 2

| | | Clean | | | | | Attack | | | | | |
|---|---|---|---|---|---|---|---|---|---|---|---|---|
| Model | Method | P | R | AP₅₀ | AP₇₅ | AP | P | R | AP₅₀ | AP₇₅ | AP | Mean |
| Yolov5 | Undefend | 1.000 | 1.000 | 0.995 | 0.931 | 0.789 | 0.944 | 0.711 | 0.920 | 0.507 | 0.564 | 0.658 |
| (INRIA) | JPEG [9] | 1.000 | 1.000 | 0.995 | 0.933 | 0.815 | 0.952 | 0.705 | 0.931 | 0.578 | 0.572 | 0.672 |
| | SACₐ [18] | 0.977 | 0.952 | 0.974 | 0.810 | 0.675 | 0.999 | 0.997 | 0.990 | 0.987 | 0.847 | 0.752 |
| | SACₑ [18] | 1.000 | 1.000 | 0.995 | 0.939 | 0.756 | 0.944 | 0.721 | 0.925 | 0.569 | 0.566 | 0.648 |
| | Ours | 1.000 | 1.000 | 0.995 | 0.943 | 0.803 | 0.977 | 0.982 | 0.993 | 0.775 | 0.677 | 0.735 |
| Yolov5 | Undefend | 1.000 | 1.000 | 0.995 | 0.995 | 0.965 | 0.902 | 0.892 | 0.956 | 0.800 | 0.684 | 0.802 |
| (COCO) | JPEG [9] | 1.000 | 1.000 | 0.995 | 0.995 | 0.967 | 0.890 | 0.840 | 0.930 | 0.763 | 0.656 | 0.782 |
| | SACₐ [18] | 0.917 | 0.943 | 0.965 | 0.671 | 0.632 | 0.989 | 0.998 | 0.995 | 0.992 | 0.870 | 0.733 |
| | SACₑ [18] | 1.000 | 1.000 | 0.995 | 0.995 | 0.063 | 0.898 | 0.912 | 0.959 | 0.822 | 0.684 | 0.801 |
| | Ours | 1.000 | 1.000 | 0.995 | 0.995 | 0.966 | 0.945 | 0.957 | 0.955 | 0.833 | 0.710 | 0.819 |

As shown in Table 2, the present disclosure (Ours) maintains high detection performance for images without adversarial attacks (Clean), while also maintaining higher human detection performance for images with adversarial attacks (Attack) than other algorithms, thereby providing a more balanced performance compared to other models.

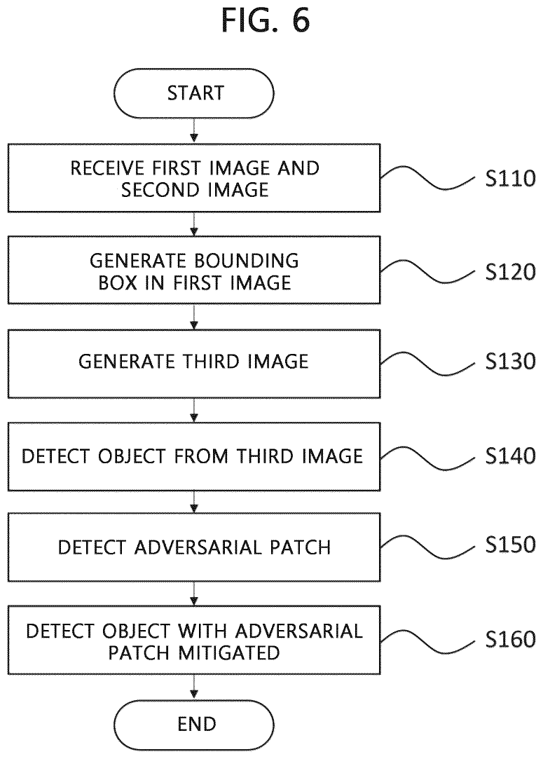

FIG. 6 is a schematic flowchart of a method for defending a human detection model against adversarial patch attacks according to another exemplary embodiment of the present disclosure.

The method for defending a human detection model against adversarial patch attacks according to the present disclosure may be performed by an apparatus for defending a human detection model against adversarial patch attacks, which includes one or more processors and a memory.

First, a first image and a second image are received (S110).

The first image and the second image may be received, for example, from a user terminal (not shown), or from an external storage device or through the Internet. The first image and the second image may also be images previously stored in the memory, and in such a case, the first image and the second image may be received based on a user input or selection.

The first image may be a thermal image captured by an infrared camera, and the second image may be an RGB image captured by an optical camera.

The first image and the second image are images obtained by capturing the same object from the same viewpoint and with the same field of view.

Next, a bounding box for a region in which an adversarial patch is expected to be present in the first image is generated (S120).

Since an adversarial patch in a thermal image appears in a color different from that of an object such as a person or an animal, the first image is segmented by using this property, and a bounding box is generated for a region in which an adversarial patch is expected to be present. A detailed method for generating the bounding box has been described above.

When the bounding box is generated from the first image, a third image is generated by using the bounding box to mask a corresponding region in the second image (S130).

Since a plurality of bounding boxes may be generated, the third image may likewise be generated as a plurality of images in which the masked regions differ from one another.

An object is detected in the third image, which is obtained by masking the second image that is an RGB image, by using a pretrained artificial intelligence model (S140).

The object may be a person, although the present disclosure is not limited thereto.

If, as a result of object detection, a person is detected in the third image but not detected in the second image, it may be determined that an adversarial patch has been detected in the second image (S150).

Without comparing the object detection result of the second image, an object in which the adversarial patch has been mitigated may also be detected in the third image (S160).

Object detection is performed on the plurality of third images in which the regions expected to contain an adversarial patch are masked, and the image having the highest confidence score is selected as an image in which the adversarial patch has been mitigated.

In such a case, the location of the bounding box may be detected as the location of the adversarial patch, and an effect is achieved in that the desired object can be normally detected by eliminating or mitigating the influence of the adversarial patch.

According to the apparatus and method for defending a human detection model against adversarial patch attacks of the present disclosure, as described above, an effect is obtained in that the presence of an adversarial patch can be detected, or human detection with the adversarial patch mitigated can be achieved, by additionally using a thermal image without modifying an existing object detection model.

In the detailed description of the present disclosure, although specific embodiments have been described, it is apparent that various modifications are possible without departing from the scope of the present disclosure. Therefore, the scope of the present disclosure is not limited to the described embodiments and should be defined by the following claims and their equivalents.

What is claimed is:

1. An apparatus for defending a human detection model against adversarial patch attacks, the apparatus comprising:
a memory storing one or more instructions; and
a processor configured to execute the one or more instructions stored in the memory,
wherein the processor is configured to:
receive a first image and a second image, the first image and the second image being images obtained by capturing a same object with a same field of view;
select, in the first image, a region where an adversarial patch is expected to be present;
generate a third image by masking, in the second image, a region corresponding to the region selected from the first image; and
detect an object by using the third image.

2. The apparatus of claim 1,
wherein the first image is a thermal image captured by an infrared camera, and
wherein the second image is an RGB image captured by an optical camera.

3. The apparatus of claim 1, wherein the object is a person or an animal.

4. The apparatus of claim 1,
wherein the memory stores an object detection artificial intelligence model, and
wherein the processor is configured to compare object detection results obtained from the second image and the third image by using the object detection artificial intelligence model, and to determine whether an adversarial patch is present in the second image.

5. The apparatus of claim 1,
wherein the memory stores an object detection artificial intelligence model, and
wherein the processor is configured to perform object detection on each of the plurality of third images by using the object detection artificial intelligence model and to obtain an object detection result from an image having a highest confidence score.

6. The apparatus of claim 4, wherein the object detection artificial intelligence model is a YOLOv5 model.

7. The apparatus of claim 1,
wherein the processor is configured to:
convert the first image into a Lab color space and perform an initial segmentation;
measure similarity of the initially segmented regions based on color, size, and fill; and
merge regions having high similarity to generate a bounding box as a region where an adversarial patch is expected to be present, thereby selecting, in the first image, a region where an adversarial patch is expected to be present.

8. A method for defending a human detection model against adversarial patch attacks, the method being performed by an apparatus for defending a human detection model against adversarial patch attacks, the apparatus comprising one or more processors and a memory, the method comprising:
receiving a first image and a second image, the first image and the second image being images obtained by capturing a same object with a same field of view;
selecting, in the first image, a region where an adversarial patch is expected to be present;
generating a third image by masking, in the second image, a region corresponding to the region selected from the first image; and
detecting an object by using the third image.
